(19) United States
(12) Patent Application Publication
(10) Pub. No.: US 2005/0140101 A1
(43) Pub. Date: Jun. 30, 2005

(54) Snow sled having steerable foot rudders

(75) Inventors: Andrew F. Fireman, North Bethesda, MD (US); Thomas B. Eckert, Rancho Cucumonga, CA (US)

Correspondence Address: KOLISCH HARTWELL, P.C., 520 S.W. YAMHILL STREET, SUITE 200, PORTLAND, OR, 97204, US

(73) Assignee: Wham-O, Inc.

(21) Appl. No.: 11/069,597

(22) Filed: Feb. 28, 2005

Related U.S. Application Data
(63) Continuation of application No. 10/024,588, filed on Dec. 18, 2001.

(51) Int. Cl. B62B 15/00

(52) U.S. Cl. 280/18

(57) ABSTRACT

The present invention is a snow sled for use by a rider to glide upon a snow surface. In one embodiment, the snow sled comprises a front portion and a rear portion. The front portion comprises a median portion and first and second foot rudder cavities each comprising a bottom wall having an upper surface adapted to receive the rider's foot and an lower surface adapted to slide upon the snow. The rear portion comprises a seat portion having a bottom wall having an upper surface adapted to receive the rider and a lower surface adapted to slide upon the snow. The snow sled further comprises a plurality of first ribs extending substantially from the median portion to the first rudder cavity and a plurality of second ribs extending substantially from the median portion to the second rudder cavity to allow said first and second foot rudder cavities to be flexible relative to said median portion thereby allowing the rider to steer the sled by exerting a force to said first or second foot rudder cavities.

### CROSS-REFERENCES TO RELATED APPLICATIONS

This application is a continuation of U.S. patent application Ser. No. 10/024,588, which is incorporated herein by reference in its entirety for all purposes.

### BACKGROUND OF THE INVENTION

A wide variety of snow sleds have been designed that allow a person to steer the sled as it slides down a hill of snow. Such designs have focused on a steering mechanism located at the front of the sled that require the person to lie flat on their stomach. Such conventional designs are not suited for all children and adults: many children and adults do not feel comfortable lying on their stomach while sliding down a hill.

### SUMMARY OF THE INVENTION

The present invention is a snow sled for use by a rider to glide upon a snow surface. In one embodiment, the snow sled comprises a front portion and a rear portion. The front portion comprises a median portion and first and second rudder cavities each comprising a bottom wall having an upper surface adapted to receive the rider's foot and an lower surface adapted to slide upon the snow. The rear portion comprises a seat portion having a bottom wall having an upper surface adapted to receive the rider and a lower surface adapted to slide upon the snow. The lower surface of the first and second rudder cavities and the lower surface of the seat portion being in exclusive contact with the snow surface thereby providing a fast sled. The snow sled further comprises a plurality of first ribs extending substantially from the median portion to the first rudder cavity and a plurality of second ribs extending substantially from the median portion to the second rudder cavity to allow said first foot and second rudder cavities to be flexible relative to said median portion thereby allowing the rider to steer the sled by exerting a force to said first or second rudder cavities.

### BRIEF DESCRIPTION OF THE DRAWINGS

The following detailed description of the invention will be more fully understood with reference to the accompanying drawings in which:

FIG. 1 is a perspective view of the snow sled of the present invention;

FIG. 2 is top plan view of the snow sled;

FIG. 3 is a bottom plan view of the snow sled;

FIG. 4 is a side elevation view of the sled;

FIG. 5 is a front elevation view of the sled;

FIG. 6 is a rear elevation view of the sled;

FIG. 7 is a cross-section view taken along line 7-7 of FIG. 2;

FIG. 8 is a cross-section view taken along line 8-8 of FIG. 2; and

FIGS. 9 and 10 are cut-away views showing the rib portions.

### DETAILED DESCRIPTION OF THE PREFERRED EMBODIMENTS

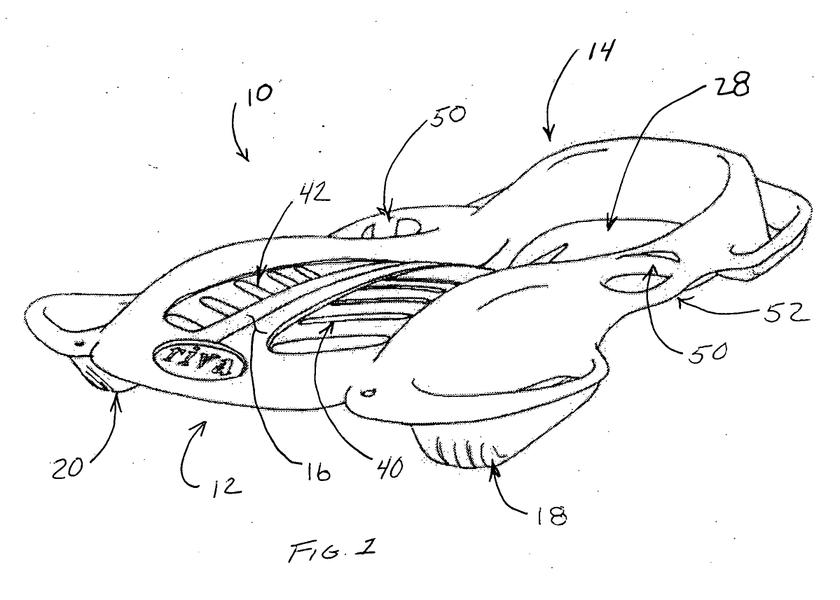

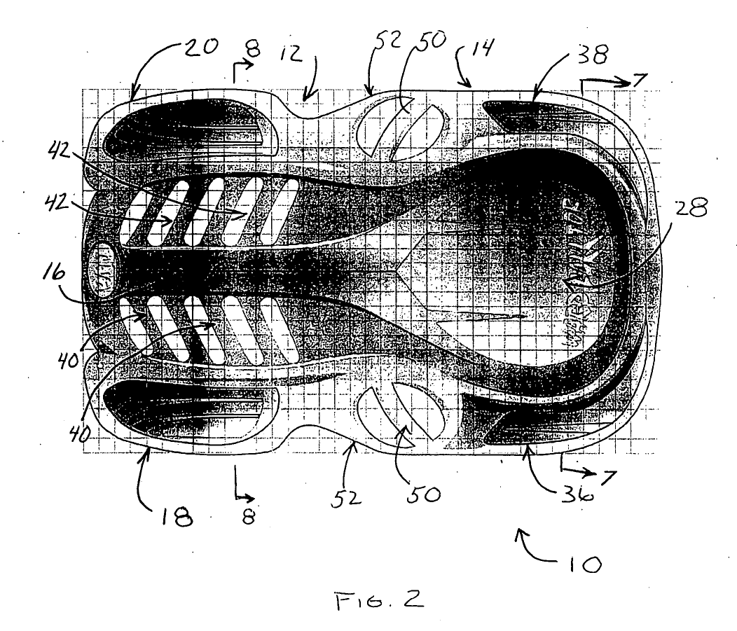

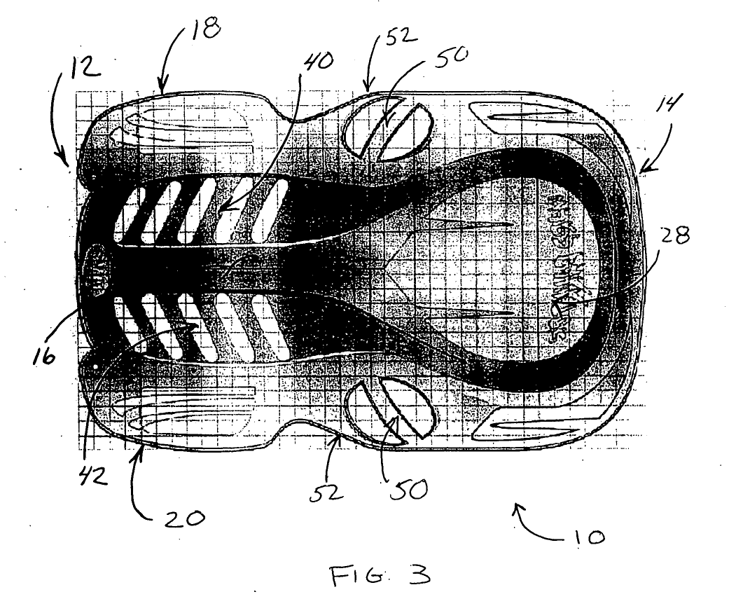

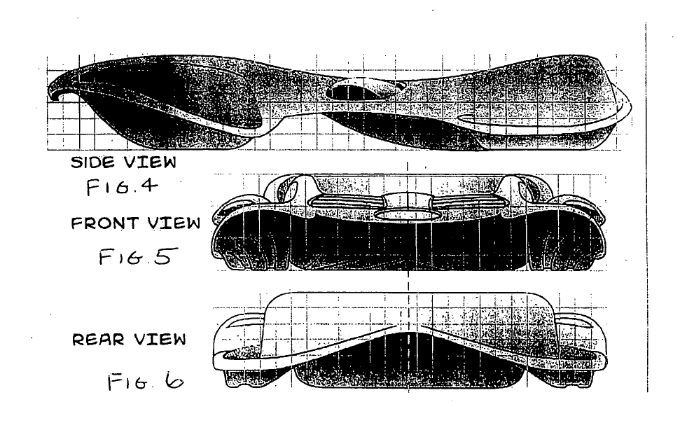

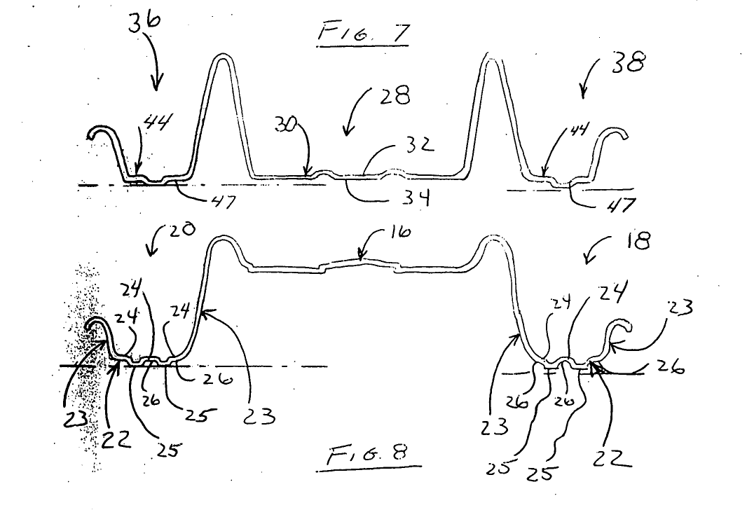

Referring to FIGS. 1-6, the present invention is a snow sled 10 for use by a rider (not shown) to slide upon a snow surface (not shown). In one embodiment, the snow sled 10 comprises a front portion 12 and a rear portion 14. The front portion 12 comprises a median portion 16 and first and second foot rudder cavities 18 and 20. Each of the foot rudder cavities 18 and 20 is formed with a bottom wall 22 and side walls 23′. The bottom wall 22 has an upper surface 24 that along with the inner surface of the side walls 23 are adapted to receive the rider's foot and a lower surface 26 adapted to slide upon the snow. The bottom wall 22 is formed with a plurality of channels or runners 25 protruding outward from the lower surface 26 to assist the sled in sliding upon the snow. In the front portion 12 of the sled 10, the lower surface 26 (and runners 25) of the first and second rudder cavities 18 and 20 are in exclusive contact with the snow surface thereby providing a fast sled. The rear portion 14 comprises a seat portion 28 having a bottom wall 30 having an upper surface 32 adapted to receive the rider and a lower surface 34 adapted to slide upon the snow. In another embodiment, the rear portion 14 may further comprise first and second stationary runners 36 and 38 having a bottom wall 44 and a lower surface 47 adapted to slide upon the snow to add stability to the snow sled 10. In the rear portion 14, the lower surface 34 of the seat portion 28 and the lower surface 47 of the stationary rudders 36 and 38 are in exclusive contact with the snow surface thereby providing a fast sled.

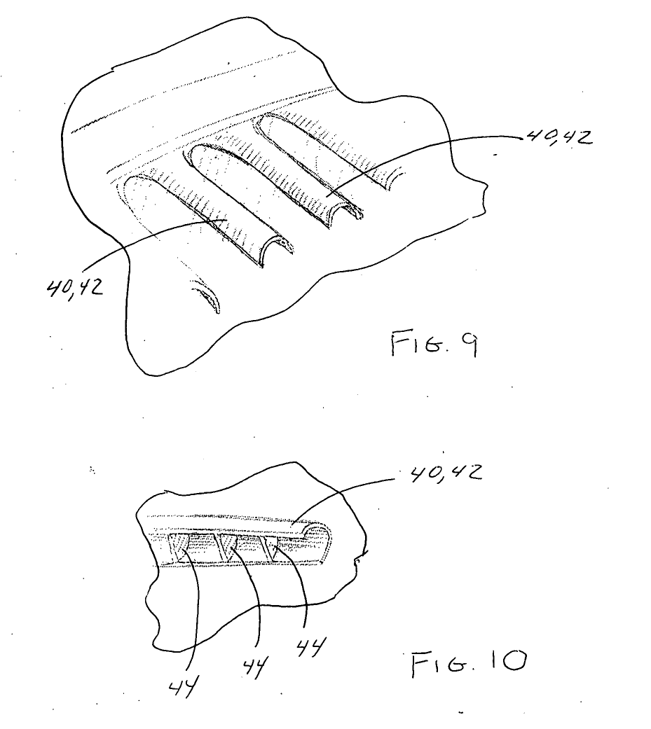

The snow sled 10 further comprises a plurality of first ribs 40 extending substantially from the median portion 16 to the first foot rudder cavity 18 and a plurality of second ribs 42 extending substantially from the median portion 16 to the second foot rudder cavity 20. As shown best by FIGS. 9 and 10, the ribs 40 and 42 are in the shape of a one-half cylinder with structural support members 44 spaced along the length of the ribs. The ribs 40 and 42 allow the first and second foot rudder cavities to be flexible relative to the median portion 16 thereby allowing the rider to steer the sled 10 by exerting a force by their foot to the first or second foot rudder cavities 18 or 20. The snow sled 10 further comprises a pair of handles 50 formed at a median portion 52 of the sled 10 and adapted to be grasp by the rider's hands. The bottom wall 22 of the first and second rudder cavities 18 and 20 have a thickness of about 0.0625 to 0.125 inches. The bottom wall 30 of the seat portion 28 has a thickness of about 0.0625 to 0.125 inches. The overall height of the sled 10 is less then twelve (12) inches. The sled 10 is preferably made from a plastic material such as polyethylene and formed by an injection molding process.

The foregoing description is intended primarily for purposes of illustration. This invention may be embodied in other forms or carried out in other ways without departing from the spirit or scope of the invention. Modifications and variations still falling within the spirit or the scope of the invention will be readily apparent to those of skill in the art.

1. A sled for use by a rider to glide upon a snow surface, the sled comprises a front portion and a rear portion, said front portion comprising a median portion and first and second foot rudder cavities each comprising a bottom wall having an upper surface adapted to receive the rider's foot and an lower surface adapted to slide upon the snow, said rear portion comprising a seat portion having a bottom wall having an upper surface adapted to receive the rider and a lower surface adapted to slide upon the snow, said lower surface of said first and second foot rudder cavities and said lower surface of said seat portion being in substantially exclusive contact with the snow surface thereby providing a fast sled; the first and second foot rudder cavities connected to the median portion to be flexible relative thereto.

2. The snow sled of claim 1, further comprising a plurality of first ribs extending substantially from said median portion to said first foot rudder cavity and a plurality of second ribs extending substantially from said median portion to said second foot rudder cavity to allow said first foot and second foot rudder cavities to be flexible relative to said median portion thereby allowing the rider to steer the sled by exerting a force to said first or second rudder cavities.

3. The snow sled of claim 2, wherein said first and second ribs are of one-half cylindrical shape.
